(19) United States
(12) Patent Application Publication
(10) Pub. No.: US 2008/0136404 A1
(43) Pub. Date: Jun. 12, 2008

(54) Cam phasing system with mid-range engine shutdown

(76) Inventors: Daniel G. Gauthier, Clarkston, MI (US); Michael A. Kozan, Canton, MI (US); John H. Waller, Ann Arbor, MI (US); Daniel J. Moreno, El Paso, TX (US); Sergio Quelhas, Ann Arbor, MI (US)

Correspondence Address: DELPHI TECHNOLOGIES, INC., M/C 480-410-202, PO BOX 5052, TROY, MI, 48007, US

(21) Appl. No.: 12/069,476

(22) Filed: Feb. 11, 2008

Related U.S. Application Data
(63) Continuation of application No. 11/415,333, filed on May 1, 2006.

(51) Int. Cl. G01B 7/30

(52) U.S. Cl. 324/207.2; 324/207.25

(57) ABSTRACT

A camshaft phaser system includes an oil control spool valve having two opposing springs to center the spool at a rest position to lock the phaser rotor by blocking supply/vent to both the C1 and C2 chambers, obviating a conventional locking pin mechanism. A double-acting solenoid actuator moves the spool to first and second positions, supplying or venting C1 and C2, respectively. The rotor may be locked hydraulically at any position between full advance and full retard. A system for monitoring the rotational positions of the crankshaft and camshaft includes magnets disposed on opposite sides of the shaft axis. A magnetic sensing element senses the rotational direction of the magnetic field for each position of the shaft. An engine control module uses the position signal and an algorithm to lock the rotor at a desired position.

### CROSS-REFERENCE TO RELATED APPLICATIONS

This application is a continuation of U.S. application Ser. No. 11/415,333, which was filed on May 1, 2006.

### TECHNICAL FIELD

The present invention relates to phasers used in conjunction with intake and/or exhaust camshafts for varying the timing of combustion valves in internal combustion engines; more particularly, to means for arresting a phaser rotor at a mid-position in its rotational range of authority; and most particularly, to a cam phasing hydraulic apparatus and method for providing such arresting.

### BACKGROUND OF THE INVENTION

Vane-type camshaft phasers for varying the timing of combustion valves in an internal combustion engines are well known. In a vane-type phaser, timing advance and retard chambers are formed within the phaser between inwardly-extending lobes of a generally cylindrical stator and outwardly-extending vanes of a rotor concentrically disposed within the stator. For convenience, these chambers are referred to in the art, and also herein, as C1 and C2, respectively. The stator is mechanically coupled and indexed to the rotational position of the engine crankshaft, and the rotor is mechanically coupled to the camshaft.

Typically, a camshaft phaser includes an oil control valve for controlling oil flow into and out of the C1 and C2 chambers to rotate the rotor with respect to the stator. The valve receives pressurized oil from an oil gallery in the engine block and selectively distributes oil to controllably vary the phase relationship between the engine's camshaft and crankshaft. By using pulse width modulated (PWM) control of the oil valve, cam timing is altered by command from an engine control module (ECM). For example, when the commanded duty cycle is less than 50%, on average the supply oil is directed to the C1 chamber and the C2 chamber is vented to the engine crankcase. The reverse of this occurs when the commanded duty cycle is greater than 50%. In this manner, the oil control valve is a throttle and direction control valve that modulates cam position and the speed with which it changes from one position to another.

A typical prior art phaser used on an intake valve camshaft includes a mechanical locking pin for rotationally locking the rotor to the stator under certain engine operating conditions, for example, at start-up, and then unlocking the rotor under other conditions to permit advance and retard of valve timing. Typically, a slidable spring-loaded pin is disposed within a bore in the rotor, having either an axial or radial direction of action, and is latched into a keyway or bore in the stator by action of the spring when oil pressure is removed from the engagement end of the pin. Unlatching occurs when oil pressure is applied to the end of the latched pin, typically simultaneously with a commanded oil-driven action of the rotor.

Several problems are known to exist with pin-latched prior art vane-type phasers.

Timing the position of the rotor with respect to the stator to assure full entry of the pin into the latching bore or keyway can be difficult, and partial latching can lead to premature unlatching and damage to the phaser and/or the engine. In interference engines such as diesels, premature unlatching can lead to destructive collision of a valve head with a piston. Tapering the pin to facilitate entry is an imperfect solution as a tapered pin can disengage spontaneously more easily than can a cylindrical pin.

Unlatching the pin cleanly from the stator can be equally difficult, as torque buildup on the rotor before the pin is fully disengaged can cause the pin to bind in the bore and thus fail to unlatch at all.

Further, it will be seen that when the pressure of supplied oil falls below a certain value, the latching pin is urged to attempt to lock irrespective of the angular position of the rotor or the intended action of the phaser.

In older prior art phasers, latching between the rotor and stator is provided at only one location, typically, in the case of an intake valve camshaft, at a full valve retard position of the camshaft, and the nominal range of phaser authority between the rotor and stator is about 30 camshaft degrees. The full retard position, referred to herein as zero degrees, is where the intake valve camshaft should be for engine start-up, and the full advance position, referred to herein as 30 degrees, is where the intake valve camshaft should be for full power when the engine is running.

In the prior art, the phaser hydraulics and hydraulic controls can hold the rotor at any desired position between full retard and full advance while the engine is running. However, when the engine is shut off and the oil pressure goes to zero, the system cannot rigidly hold the rotor at zero degrees for restart of the engine; hence the need to mechanically hold the rotor by means of a locking pin.

Recently, it has been found that fuel economy can be improved in some modes of engine operation if the rotor and camshaft are retarded still further than the standard zero degrees; however, the rotor must still be positioned at zero degrees for engine start-up. One way to do this is to simply shift the 30 degree range of authority so that, relative to the prior art range, a new 30 degree range starts at minus 10 degrees and ends at plus 20 degrees (or increase the range of the phaser to 40 degrees and set the range from minus 10 degrees to plus 30 degrees). The locking pin is then placed at the zero degree position for engine start-up.

Further in the prior art, it has been found beneficial to engage the rotor to the stator at one or more mid-range positions under some engine operating conditions; hence, newer prior art phasers may include multiple keyways from which a desired rotational mid-range latching position may be selected. See, for example, U.S. Pat. No. 6,772,721 ('721) and U.S. Pat. No. 6,311,655 ('655).

A typical prior art oil control valve for a phaser is a spool valve having a single-acting solenoid for driving the spool in a first direction with respect to the valve body and a return spring for driving the spool in the opposite direction. The '721 reference discloses a spool valve that operates in such a way that the oil pathways to the C1 and C2 chambers are shut off simultaneously at a mid-position of the actuator stroke, which captures oil in both C1 and C2 and thus immobilizes the rotor. Such mid-range positioning can be useful in helping to engage the locking pin onto the stator. However, maintaining this position requires that the single-acting solenoid actuator remain energized and controlled. This position cannot be the rest position of the spool when the solenoid is deactivated because further solenoid travel is required to supply the C2 (retard) chamber and vent the C1 chamber, which is the rest position of the solenoid actuator as driven by the return spring. Thus, deactivating the solenoid when the pin is engaged at a mid-range position of the spool and solenoid would allow the return spring to put an undesirable torque on the pin in the latching bore, which can inhibit or prevent later unlatching of the pin from the bore.

In the prior art, engine speed and relative crank/cam phase are monitored with dynamic proximity sensors that change state with passing tooth and slot features on target wheels driven by the crankshaft and camshaft. This approach has significant positioning limitations for future phaser control, especially at low engine speeds. It requires a timing feature in a timing wheel, such as a unique slot or tooth geometry, to identify the start of rotation and the absolute angular position of the shaft; therefore, a full rotation may be necessary for the timing feature to pass the sensor. The angular resolution depends upon the number of teeth and slots in the target wheel; since proximity sensors typically use magnetic technology, there is a lower limit on the size of the features in the wheel. Changes in direction of rotation of the target wheels cannot be detected. The system becomes progressively less reliable at speeds below 150 rpm, as are experienced during engine shutdown.

What is needed in the art is a camshaft phaser system capable of positioning and holding its rotor at any desired position between full advance and full retard.

What is further needed in the art is a camshaft phaser system wherein the rotor may be automatically locked and retained in a mid-range position upon engine shutdown without the use of a mechanical pin lock.

What is still further needed in the art is a position sensing system for accurate measurement of crankshaft and camshaft (and, hence, rotor and stator) positions at all engine speeds, including zero rpm.

It is a principal object of the present invention to position and lock a phaser rotor within its stator at a predetermined mid-position in its range of authority.

It is a further object of the invention to improve fuel economy in an internal combustion engine.

### SUMMARY OF THE INVENTION

Briefly described, a vane-type camshaft phasing system includes an oil control spool valve for controlling oil flow into and out of the C1 and C2 chambers to rotate the phaser rotor with respect to the phaser stator. The valve receives pressurized oil from an oil-gallery in the engine block and selectively distributes oil to controllably vary the phase relationship between the engine's camshaft and crankshaft. The hydraulic design of the valve is conventional; however, two opposing springs act to center the spool at a rest position blocking supply/vent to both the C1 and C2 chambers, thus hydraulically locking the rotor in place when a solenoid actuator for the spool is de-energized. The actuator is double-acting to move the spool in either a first direction to a first position supplying C1 and venting C2 or a second and opposite direction to a second position supplying C2 and venting C1. A conventional locking pin mechanism is thus obviated, and the rotor may be locked hydraulically to the stator at any position in the phaser range of authority between full advance and full retard by simply de-energizing the actuator when the rotor is at the desired location; the springs will immediately move the spool to the supply/vent blocking position for both chambers.

A means for very accurately and continuously monitoring the rotational positions of each of the crankshaft and camshaft includes magnets disposed non-coaxially of the shaft axis on a non-ferromagnetic plate disposed on the end of the shaft. A preferred embodiment comprises first and second fixed magnets having aligned magnetic fields and disposed on opposite sides of the shaft axis. A fixed magnet sensing element, preferably of either the Hall or magneto-resistive type, is positioned in space in a plane of detection adjacent the magnet means, preferably on the shaft axis. As the magnet means rotate about the sensing element during engine operation, the shaft rotation changes the magnitude and direction of the net magnetic field such that a unique magnetic field exists for each angular position of the shaft. The sensor generates a voltage output signal that is continuous, thus improving the resolution of shaft position measurement. The magnitude, slope, and slope sign are unique for each angular position. The signal is sent to an engine control module which determines when the solenoid actuator must be energized and then energizes the solenoid to lock the rotor at the predetermined desired position in its range of authority.

Because the sensor determines the magnetic orientation of the magnet, and hence the shaft, at any instant, the detection system is independent of shaft rotation speed and is fully functional at a shaft speed of zero (engine shutdown), unlike prior art optical or magnetic signal-chopping systems.

### BRIEF DESCRIPTION OF THE DRAWINGS

The present invention will now be described, by way of example, with reference to the accompanying drawings, in which:

FIG. 1 is a cross-sectional view of a first prior art camshaft phaser, substantially as shown in FIG. 3 in U.S. Pat. No. 6,311,655, showing an axially-operative rotor-locking pin mechanism;

FIG. 2 is cross-sectional view of a second prior art camshaft phaser, substantially as shown in FIG. 7 in U.S. Pat. No. 6,311,655, showing a radially-operative rotor-locking pin mechanism;

FIG. 3 is a schematic control diagram for a camshaft phaser system in accordance with the invention;

FIG. 4 is a cross-sectional view of an oil control valve for the camshaft phaser system shown in FIG. 3;

FIG. 5 is a graph showing oil flow through the valve shown in FIG. 4 as a function of duty cycle in a pulse-width modulated flow control system;

FIG. 6 is an isometric view from the front of a shaft position sensing system in accordance with the invention, showing signal-generating elements on a rotating shaft and signal-sensing elements on a stationary mount, the elements being turned out of operating position (axis bent) for convenience of presentation;

FIG. 7 is an elevational view of the apparatus shown in FIG. 6, shown in operational configuration; and

FIG. 8 is a graph showing shaft-position signals generated by the signal-sensing elements in FIGS. 6 and 7.

The exemplification set out herein illustrates one preferred embodiment of the invention, in one form, and such exemplification is not to be construed as limiting the scope of the invention in any manner.

### DESCRIPTION OF THE PREFERRED EMBODIMENTS

The benefits and advantages of a camshaft phaser system in accordance with the invention may be better appreciated by first considering first and second prior art phasers having locking pin mechanisms.

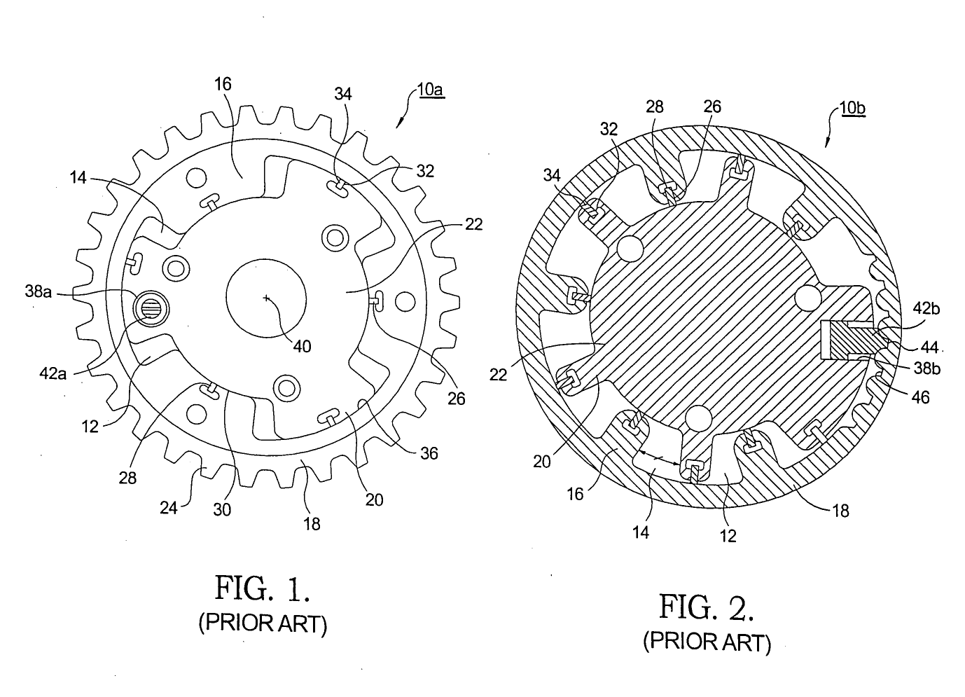

Referring to FIG. 1, in a first prior art camshaft phaser 10a, timing advance and retard chambers 12,14 are formed within the phaser between inwardly-extending lobes 16 of a generally cylindrical stator 18 and outwardly-extending vanes 20 of a rotor 22 concentrically disposed within stator 18. Chambers 12,14 are referred to herein as C1 and C2, respectively. Stator 18 is surrounded by and attached to a driving member 24, exemplarily shown as a sprocket wheel, for driving stator 18 in synchrony with an engine crankshaft (not shown). Each lobe 16 includes a radial slot 26 opening inward and provided with a wiper 28 for wiping opposing surface 30 of rotor 22 to prevent oil leakage past the stator lobes between the advance and retard chambers. Likewise, each vane 20 includes a radial slot 32 opening outward and provided with a wiper 34 for wiping opposing surface 36 of stator 18 to prevent oil leakage past the rotor vanes between the advance and retard chambers. One vane 20 of rotor 22 includes a bore 38a having an axis parallel to phaser axis 40 for housing a locking pin 42a therein. Pin 42a is axially actuable in bore 38a as described above to rotationally lock rotor 22 to the hub (not shown) of stator 18.

Referring to FIG. 2, a second prior art camshaft phaser 10b is similar in overall construction to first phaser 10a, having a rotor 22 disposed within a stator 18, and having interlocking stator lobes 16 and rotor vanes 20 defining a plurality of advance and retard chambers 12,14 as well as wipers 28,34 disposed in slots 26,32 in the lobes and vanes. The only significant difference is that the locking pin bore 38b is radially oriented in rotor 22 such that locking pin 42b is radially actuable in bore 38b to rotationally lock rotor 22 to stator 18. Note that pin 42b is provided with a spade tip 44 for engaging any one of a plurality of keyways 46 in stator 18 such that the rotor may be locked to the stator at any one of a plurality of discrete angular positions.

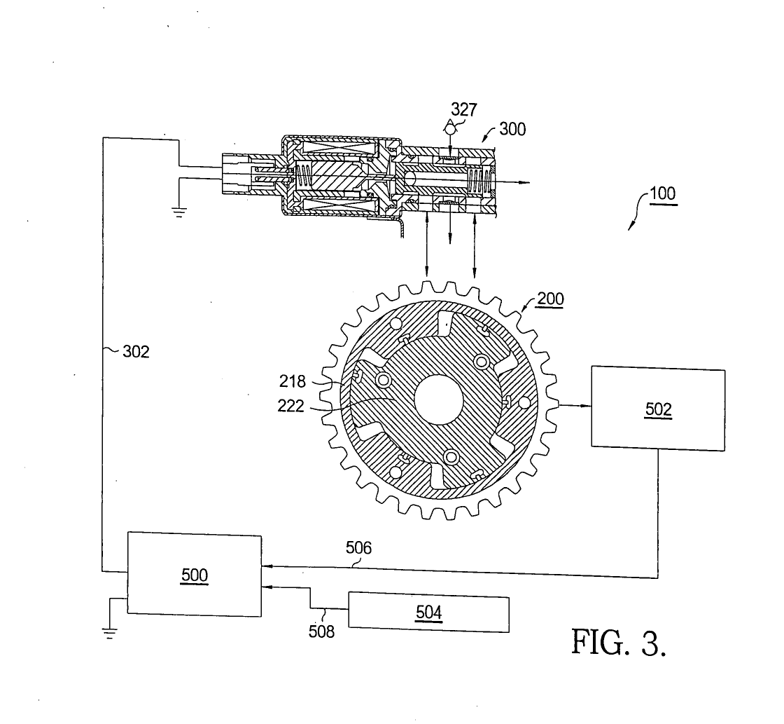

Referring now to FIG. 3, a camshaft phasing system 100 in accordance with the invention comprises an improved phaser 200, an improved oil control valve 300, an improved camshaft rotational position sensing system 502 and improved crankshaft rotational position sensing system 504, and an engine control module (ECM) 500.

In general operation, ECM 500 employs an algorithm to command oil control valve 300 via signal 302 to supply oil selectively to the advance and retard chambers of phaser 200. Position sensing system 502 senses the instantaneous rotational position of the phaser rotor, which is fixed to an end of the rotating camshaft, and sends a corresponding signal 506 to ECM 500. Position sensing system 504 senses the instantaneous rotational position of the engine crankshaft (not shown) and sends a corresponding signal 508 to ECM 500. Because the phase relationship of the stator to the crankshaft is fixed, ECM 500 is thus able to compute continuously the instantaneous rotational relationship between the crankshaft and the camshaft, and hence the phase relationship of the engine valves to the pistons. As described below, at any desired position of the rotor in its range of authority, valve 300 may be arrested in a position such that, in a currently preferred embodiment, oil is neither supplied to or vented from either the advance chambers or the retard chambers, thus rendering those chambers hydraulically rigid.

In an alternative embodiment, oil may be supplied to both the advance chambers and the retard chambers simultaneously, thus also rendering the chambers hydraulically rigid and arresting the rotor; however, this alternative is not currently preferred, since over time the captive oil may leak back from the advance and retard chambers after the actuator is de-energized, thus undesirably relieving the hydraulic lock.

Phaser 200 is substantially the same as either of prior art phasers 10a,10b, and respective parts and numbers need not be repeated here, except that in a preferred embodiment of the invention the prior art locking pin mechanisms, either axially-operable or radially operable, are omitted entirely. Such mechanisms are not necessary (although may be employed optionally as desired) in a system in accordance with the invention, as the rotor may be maintained solely by hydraulics at whatever rotational position is dictated by the ECM 500, as described below. Thus it will be seen that rotor 222 may be arrested within stator 218 at an infinite number of rotational positions over its range of authority between full retard and full advance. Further, the design and construction of such a phaser is both simpler and less costly, and the above-mentioned problems that can be encountered in engaging and dis-engaging a locking pin are obviated.

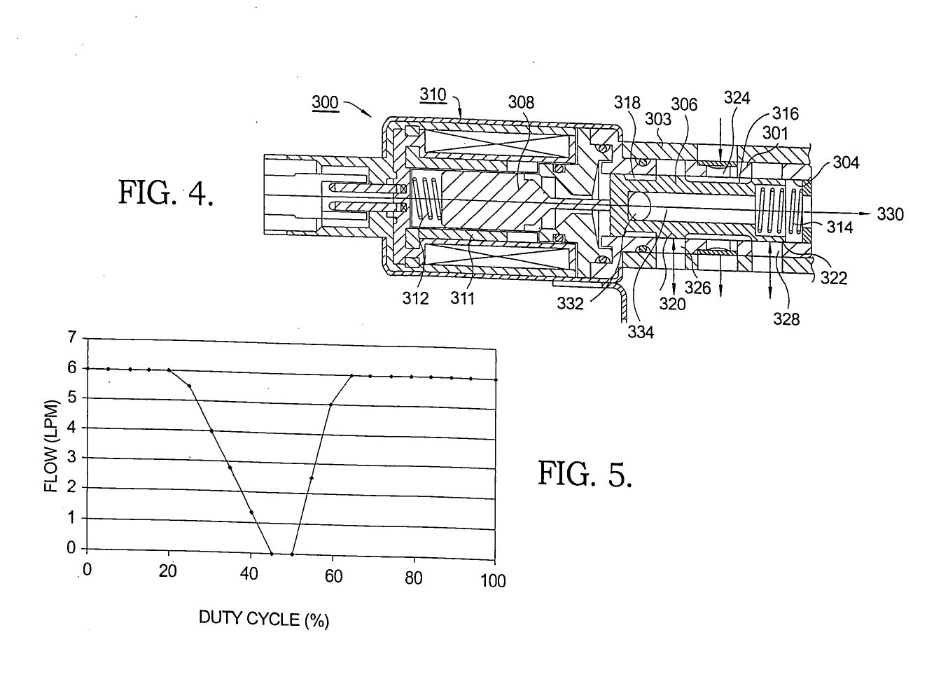

Referring now to FIG. 4, improved oil control valve 300 comprises a generally tubular valve body 301 having a cylindrical bore 304 for slidably receiving a spool 306. Preferably, body 301 is mountable into a supportive engine fixture 303. Spool 306 is connected to an armature 308 of a double-acting solenoid actuator 310. The direction of action of actuator 310 may be controlled via an electrical “H-bridge” (not shown), in an electrical arrangement well known in the prior art for controlling, for example, a bi-directional electrically-actuated throttle valve.

Spool 306 and armature 308 are disposed in bore 304 and pole piece 311 between first and second opposing compression springs 312,314 that act to drive spool 306 to a medial position (shown in FIG. 4) within bore 304 when solenoid actuator 310 is de-energized.

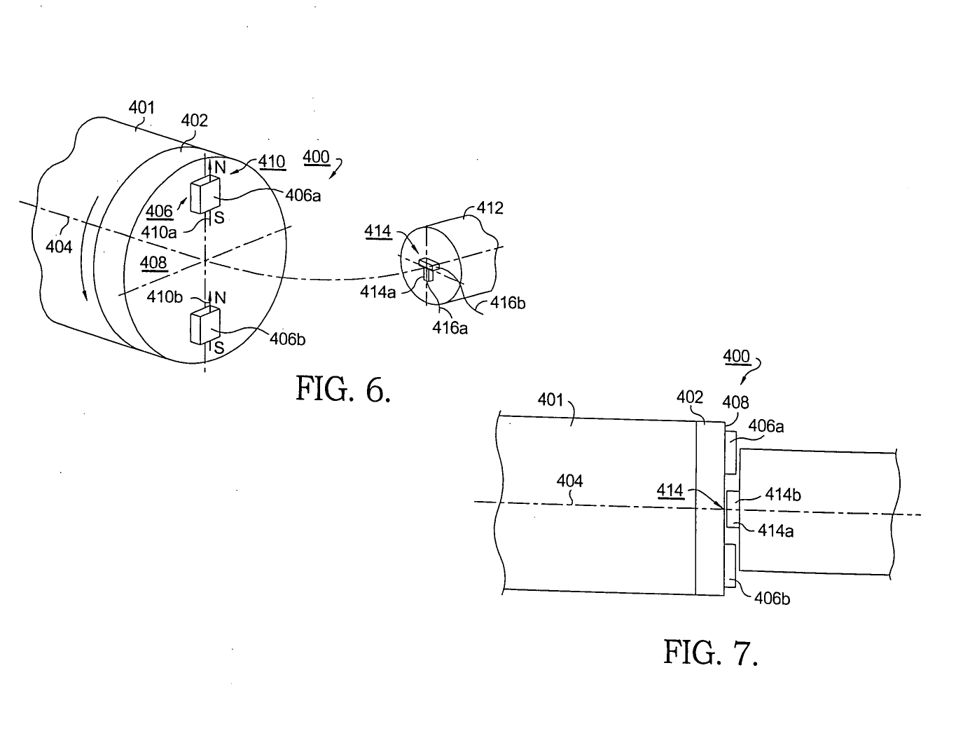

The hydraulic arrangement of valve 300 is substantially known in the prior art, as shown in FIG. 6, which is substantially as shown in FIGS. 5, 6, 7, and 8 of the '721 reference, the relevant material of which is incorporated herein by reference. What is novel in valve 300 is that actuator 310 is double-acting, as opposed to a single-acting actuator 70 in '721, such that spool 306 is driven to its natural medial rest position, blocking flow to all chambers, by two selected opposing springs when actuator 310 is de-energized; whereas spool 32 in the '721 reference is driven to an extreme rest position (phaser fully advanced, '721 reference, FIG. 7) by a single spring 31 a when the prior art actuator is de-energized. Optionally, a check valve 327 (FIG. 3) is provided in oil supply port 324 to insure against oil backflow during rotor-locked mode.

Spool 306 is provided with first and second annular recesses 316,318 separated by a first land 320 and ending in a second land 322. First recess 316 extends axially of the spool by a length sufficient to be open to oil inlet port 324 over the entire range of spool motion. At a leftward extreme of spool motion (leftward being as shown in FIG. 4), oil inlet port 324 is connected to oil advance outlet 326. Second land 322 is of such an axial length that, in this spool position, oil retard outlet 328 is opened to bore 304 and hence to vent 330. At the opposite or rightward extreme of spool motion as shown in FIG. 4, first recess 316 communicates with oil retard outlet 328, and oil advance outlet 326 is vented via second recess 318 which is intersected by a radial port 332 connecting to axial vent bore 334.

In operation, when solenoid actuator 310 is de-energized, spool 306 is in the position shown in FIG. 4, being so positioned by the combined action of springs 312,314. To advance valve timing, solenoid actuator 310 is energized in a first polarity to drive spool 306 to the left, connecting oil supply port 324 to advance port 326 and venting retard port 328. To retard valve timing, solenoid actuator 310 is energized in a second and opposite polarity to drive spool 306 to the right, connecting oil supply port 324 to retard port 328 and venting advance port 326.

Referring to FIG. 5, a preferred mode of control of valve 300 is via pulse-width modulation (PWM) wherein the actuator is alternatively energized in opposite directions. FIG. 5 shows the total flow of oil through valve 300 as a function of percent duty cycle. At duty cycles less than about 25%, the phaser is in full advance (or retard, depending upon piping), and above about 65% the phaser is in full retard (or advance). In the in between range, the phaser is effectively throttled at positions intermediate to its range of authority. Of especial interest is that at a duty cycle around 50%, there is no flow through the valve, and hence the phaser is hydraulically rigid under this condition. Note that this also corresponds to the position the spool will assume when the actuator is simply de-energized; 50% duty cycle is the equivalent of de-energizing the actuator.

Referring to FIGS. 6 and 7, showing exemplary shaft position sensor 400 in accordance with the invention, a rotatable shaft 401, such as a camshaft, camshaft phaser, or a crankshaft, is provided with a non-ferromagnetic mounting plate 402 on an end thereof. Shaft 401 has an axis of rotation 404. At least one permanent magnet 406 is mounted on an axial surface 408 of plate 402, preferably with its magnetic axis 410 intersecting shaft axis 404. In a currently preferred embodiment, two permanent magnets 406a,406b are mounted on surface 408 on opposite sides of a plane positioned along axis 404 and having their magnetic axes 410a,410b aligned. The magnets create a magnetic field (not shown) including a planar region parallel to surface 408, which magnetic field has an axis including the axes of magnets 406a,406b and spaced apart therefrom. It will be seen that as shaft 401 rotates, the magnetic field and field axis also rotate. On a stationary mount 412 is disposed magnetic sensor 414 which, in operating position (FIG. 7), is disposed within the magnetic field between magnets 406a,406b. In a currently preferred embodiment, magnetic sensor 414 includes at least one linear Hall sensor positioned on or adjacent to axis 404. Hall sensors are well known in the art for detecting magnetic field strength as a function of polarity with respect to the sensor, having minimum output when aligned with the magnetic field axis and maximum output when orthogonal to the magnetic field axis. In a still more preferred embodiment, sensing means 414 comprises first and second linear Hall sensors 414a,414b disposed orthogonally to each other, each having a respective lead 416a,416b for transmitting individual signals to ECM 500 (FIG. 3).

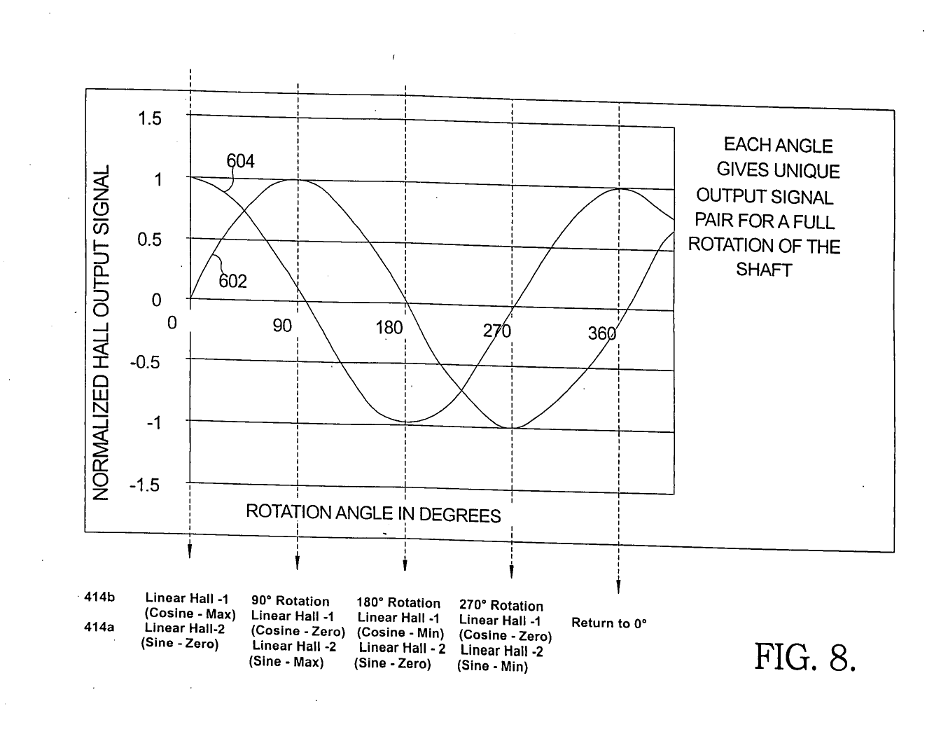

Referring to FIG. 8, signals from Hall sensors 414a,414b generated by rotation of a magnetic field are sinusoidal in form as a function of the rotational angle between the axis of the field and the axis of the sensor. Thus in the sensor positions shown in FIGS. 6 and 7 with respect to the magnetic axes, output curve 602 shows zero beginning output for first sensor 414a which is parallel to the magnetic field (sine output curve), and output curve 604 shows maximum output for second sensor 414b which is orthogonal to the magnetic field (cosine output curve). Thus, as the magnetic field rotates (as caused by rotation of shaft 401), there is a unique combination of sine and cosine values for every angular position of the shaft, such that ECM 500 is able to infer the instantaneous angular position of the shaft at any given time.

An important aspect of sensing means assembly 400 is its independence of speed of rotation of the shaft; it is not a dynamic system. Thus, unlike prior art dynamic beam-choppers or field choppers, the angular position of the shaft is known even when the shaft speed is zero, a significant advantage during engine shutdown and startup sequences.

It will be seen that a sensing system suitable for use in accordance with the present invention may comprise only a single magnet 406 and a single sensor 414, generating a single sinusoidal output curve. However, ECU 500 must be programmed to determine the sign and magnitude of the slope of the curve at any given time because of ambiguity in using the actual values of the sine; there are equal sine values for both the positive and negative slope curve portions in both the positive and negative regions of the total curve. Slope sign and magnitude are readily determined by simple time-averaging of adjacent readings, with a necessary slight loss in response instantaneity. However, it is currently preferred to employ two magnets 406a,406b to increase the strength of the magnetic field, and to employ two orthogonal sensors to provide unambiguous instantaneous locating of the rotor within the stator.

In a currently preferred embodiment of the invention, a sensor assembly 400 is employed for each of shaft position sensors 502,504 (FIG. 3) such that the precise angular position of phaser rotor 222 with respect to phaser stator 218 is known at all times and thus may be used by ECM 500 in determining when to de-energize oil supply valve 300 to fix the rotor within the stator by capturing oil within the C1 and C2 chambers at any desired angular position within the rotor range of authority.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A magnetic sensing system for sensing the angular position of a shaft, wherein the magnetic sensing system comprises:
at least one magnet for generating a magnetic field having a magnetic axis, said at least one magnet being disposed for rotation with said shaft; and
a magnetic sensor positioned in space from said at least one magnet to sense lo the rotational position of said magnetic field, said magnetic sensor including first and second magnetic sensors positioned at an angle with respect to one another.

2. A magnetic sensing system in accordance with claim 1 wherein said angle is approximately 90 degrees.

3. A magnetic sensing system in accordance with claim 1 wherein said first and second magnetic sensors are disposed on a stationary mount.

4. A magnetic sensing system in accordance with claim 1 wherein said first and second magnetic sensors are selected from the group consisting of Hall-type and magneto-resistive.

5. A magnetic sensing system in accordance with claim 1 wherein said shaft is one of a phaser rotor and a phaser stator.

6. A magnetic sensing system in accordance with claim 1 wherein said at least one magnet is disposed on a non-ferrous mounting plate attached to the shaft.

7. A magnetic sensing system for sensing the angular position of a shaft, wherein the magnetic sensing system comprises:
at least one magnet for generating a magnetic field having a magnetic axis, said at least one magnet being disposed for rotation with said shaft; and
a magnetic sensor positioned in space from said at least one magnet to sense the rotational position of said magnetic field, said magnetic sensor including first and second magnetic sensors that are in misaligned with one another.

8. A magnetic sensing system in accordance with claim 7 wherein said first and second magnetic sensors are positioned at an angle of approximately 90 degrees with respect to one another.

9. A magnetic sensing system in accordance with claim 7 wherein said first and second magnetic sensors are disposed on a stationary mount.

10. A magnetic sensing system in accordance with claim 7 wherein said first and second magnetic sensors are selected from the group consisting of Hall-type and magneto-resistive.

11. A magnetic sensing system in accordance with claim 7 wherein said shaft is one of a phaser rotor and a phaser stator.

12. A magnetic sensing system in accordance with claim 7 wherein said at least one magnet is disposed on a non-ferrous mounting plate attached to the shaft.

13. A magnetic sensing system for sensing the angular position of a first shaft with respect to a second shaft, wherein the magnetic sensing system comprises:
at least one magnet for generating a magnetic field having a magnetic axis, said at least one magnet being disposed for rotation with one of said first shaft and said second shaft; and
a magnetic sensor positioned in space from said at least one magnet to sense the rotational position of said magnetic field, said magnetic sensor including first and second magnetic sensors positioned at an angle with respect to one another.

14. A magnetic sensing system in accordance with claim 13 wherein said angle is approximately 90 degrees.

15. A magnetic sensing system in accordance with claim 13 wherein said first and second magnetic sensors are disposed on a stationary mount.

16. A magnetic sensing system in accordance with claim 13 wherein said first and second magnetic sensors are selected from the group consisting of Hall-type and magneto-resistive..

17. A magnetic sensing system in accordance with claim 13 wherein said first shaft is a phaser rotor.

18. A magnetic sensing system in accordance with claim 17 wherein said second shaft is a phaser stator.

19. A magnetic sensing system in accordance with claim 13 wherein said at least one magnet is disposed on a non-ferrous mounting plate attached to said one of first shaft and second shaft.

20. A magnetic sensing system in accordance with claim 13 wherein said at least one magnet is disposed for rotation with said first shaft, and wherein said magnetic sensor is disposed on the axis of rotation of said second shaft.
